(19) United States
(12) Patent Application Publication
(10) Pub. No.: US 2016/0207237 A1
(43) Pub. Date: Jul. 21, 2016

(54) PROCESS FOR THE PRODUCTION OF A COMPONENT MADE OF A POLYMER MATERIAL

(71) Applicant: BASF SE, Ludwigshafen (DE)

(72) Inventors: Andreas RADTKE, Mannheim (DE); Oliver GEIGER, Schwegenheim (DE)

(73) Assignee: BASF SE, Ludwigshafen (DE)

(21) Appl. No.: 14/912,958

(22) PCT Filed: Aug. 15, 2014
(86) PCT No.: PCT/EP2014/067495

§ 371 Date: Feb. 19, 2016

(30) Foreign Application Priority Data
Aug. 19, 2013 (EP) 13180883.4

(51) Int. Cl. B29C 45/14

(52) U.S. Cl. CPC B29C 45/14631; B29L 2031/00

(57) ABSTRACT

The invention relates to a process for the production of a component made of a polymer material via an injection-molding process comprising the following steps:
(a) insertion of a polymer-saturated fiber structure, or of a semifinished product comprising a fiber structure, into an injection mold,
(b) injection of a molten thermoplastic polymer into the injection molding in order to sheath or coat the fiber structure, or the semifinished product comprising the fiber structure,
(c) allowing the polymer to solidify, and removal of the component from the injection mold,
   where dimensions established for molten-polymer-flow channels surrounding the fiber structure, or surrounding the semifinished product comprising the fiber structure, are such that the wall thickness of the first component corresponds to the wall thickness achievable for a component without inserted fiber structure.

The invention relates to a process for the production of a component made of a polymer material via an injection-molding process comprising the following steps:
(a) insertion of a polymer-saturated fiber structure, or of a semifinished product comprising a fiber structure, into an injection mold,
(b) injection of a molten thermoplastic polymer into the injection molding in order to sheath or coat the fiber structure, or the semifinished product comprising the fiber structure,
(c) allowing the polymer to solidify, and removal of the component from the injection mold.

Components made of fiber-reinforced polymers are used by way of example in sectors where the intention is to use materials which have high strength and which weigh less than metals. Components made of fiber-reinforced polymers are in particular use in automobile construction, in order to reduce the mass of vehicles, and thus to reduce fuel consumption.

In a known method for the production of components made of fiber-reinforced polymers, fibers are first inserted into a mold, and then these are sheathed by injecting the polymers. In the case of commonly used injection-molding processes where fibers are inserted into a mold and are then sheathed, flow channels are used with a thickness in essence corresponding to the wall thickness of a component without fiber reinforcement. The components produced via sheathing of fibers are therefore always produced with greater minimal wall thickness than components without fiber reinforcement. If the intention is to produce thin sheathing, processes known from the prior art require a relatively large number of gates, in order to achieve relatively short flow path lengths. Injection of the polymer material for the sheathing or coating process moreover uses high injection pressures, another effect of which, in particular when fibers are used, is that the flow effect can cause displacement and deformation of the textiles used for fiber reinforcement.

Other products increasingly used in recent times, alongside fiber-reinforced thermoset materials, are what are known as organopanels, i.e. fully consolidated thermoplastic polymers reinforced by continuous-filament fibers, where the reinforcement is a woven fabric or a laid scrim. Polymers can be injected through these organopanels in an injection-molding process, if the organopanels are subsequently thin or are heated above melting point.

High injection pressures are moreover required in particular when injection-molding processes are used for the production of the components, to permit compensation for large pressure losses during injection through the textile. Finally, the displacement of the textile by flow effects moves the textile away from the intended direction. When steel cords or woven steel fabrics are used, which differ from organopanels in that they do not have to be in fully consolidated form, the woven fabric can be forced toward the mold wall and thus to the component surface, and protrude, or can be disinserted by flow effects. A disadvantage of this, in particular in the case of woven steel fabrics, is that protruding steel can cause corrosion problems. Coating of woven steel fabric moreover requires a minimal wall thickness which is markedly greater than the thickness of the woven fabric, in order that the polymer material encloses the woven fabric completely. This increases the quantity of material, and thus leads to disadvantages in the use of the fiber-reinforced polymers in lightweight construction.

It is an object of the present invention to provide a process which can produce fiber-reinforced components and which can also produce components with low wall thickness via injection to sheath or coat a fiber structure, or to sheath or coat a semifinished product comprising a fiber structure, where the wall thickness is smaller than in the processes known from the prior art.

The object is achieved via a process for the production of a component made of a polymer material via an injection-molding process comprising the following steps:
(a) insertion of a polymer-saturated fiber structure, or of a semifinished product comprising a fiber structure, into an injection mold,
(b) injection of a molten thermoplastic polymer into the injection molding in order to sheath or coat the fiber structure, or the semifinished product comprising the fiber structure,
(c) allowing the polymer to solidify, and removal of the component from the injection mold,
   where dimensions established for molten-polymer-flow channels surrounding the fiber structure, or surrounding the semifinished product comprising the fiber structure, are such that the wall thickness of the first component corresponds to the wall thickness achievable for a component without inserted fiber structure.

Achievement of the low wall thicknesses and, with this, the small dimensions of the flow channels is possible because it has, surprisingly, been found that when material was injected to coat fiber structures or semifinished products comprising a fiber structure the achievable flow path lengths were greater than in the absence of fiber structures or semifinished products comprising a fiber structure. It was thus possible to fill even relatively thin flow channels, and to reduce wall thickness. It has moreover been found that, because of the greater flow path length achievable the injection pressures required are also smaller, and reduced displacement of the fiber structure is therefore also achieved here.

The height of flow channels for the polymer in the mold in regions where the fiber structure or the semifinished product comprising the fiber structure is present, and the polymer therefore flows over the fiber structure or the semifinished product comprising the fiber structure, preferably permits achievement of wall thickness in the range from 0.5 to 2.5 mm, preferably in the range from 1 to 2 mm.

The sheathing or coating of the fiber structure or of the semifinished product comprising the fiber structure, permits by way of example production of components with a defined surface structure. It is moreover also possible to design the sheathed or coated product with functional elements, such as ribs, in such a way that the sheathing or coating process molds the corresponding functional elements onto the fiber structure, or onto the semifinished product comprising the fiber structure, in order to obtain a component of appropriate shape.

For the purposes of the present invention, the expression fiber structure means a woven fabric, a knitted fabric, a laid scrim, or a unidirectional or bidirectional fiber structure made of continuous-filament fibers, or means unordered fibers, where the fiber structure has been saturated with a polymer. This can be achieved either by saturating a fiber structure or else by saturating the fibers from which the fiber structure is produced. In particular when the fiber structure is a laid scrim, there can be individual fibers arranged in a plurality of layers made of parallel fibers, where the individual layers are at an angle to one another. It is particularly preferable here that the fibers of the individual layers are at an angle of from 30° to 90° to one another. The orientation of the individual layers at an angle to one another increases the tensile strength of the molding in a plurality of directions. In the event of unidirectional orientation, an increase in tensile strength is in particular achieved in the direction of fiber orientation. An increase in the compressive strength of the component made from the molding is also achieved perpendicularly to the orientation of the fibers.

When the fiber structure comprises a woven fabric or a knitted fabric, again it is possible to provide a plurality of layers, or only one layer, of fibers. In the case of a woven fabric, the expression a plurality of layers means that a plurality of woven fabrics are to be arranged on top of one another. The same also applies to an arrangement of the fiber structure in the form of knitted fabric.

Suitable fibers that can be used to increase the stability of the components are in particular carbon fibers, glass fibers, aramid fibers, metal fibers, polymer fibers, potassium titanate fibers, boron fibers, basalt fibers, or other mineral fibers. It is particularly preferable that at least a portion of the fibers used are metal fibers. Suitable metal fibers are in particular fibers based on ferrous metals, in particular based on steel.

In one embodiment the fiber structure comprises steel cords, steel wires, or steel fibers. The fiber structure here can comprise only steel cords, steel wires, or steel fibers, or a mixture of steel cords, steel wires, or steel fibers, and of nonmetallic fibers, particularly preferably carbon fibers or glass fibers.

The use of steel cords, steel wires, or steel fibers has the advantage that in particular the resultant moldings achieve high tensile strength. A substantial advantage of the use of steel cords in particular in vehicle construction is that the integrity of the component is ensured when it is subject to a collision or impact, where a glass- or carbon-fiber-reinforced structure would lose its integrity. It is particularly preferable that reinforcement uses a mixture of metal fibers and carbon fibers or glass fibers. In this case it is by way of example possible to weave individual steel cords, steel wires, or steel fibers with carbon fibers or glass fibers. Alternatively it is also possible to insert different fibers in the form of a laid scrim into the mold. The fibers here can be inserted either alternately or in any desired random sequence. It is also possible by way of example to insert fibers made of one material in one direction and fibers made of another material in a direction at an angle to said direction.

In particular when steel cords, steel wires, or steel fibers are used it is preferable that these are woven together with glass fibers or carbon fibers to obtain a woven fabric. Uniform reinforcement of the molding can be achieved by way of example in that the individual woven fabrics are arranged in a plurality of layers at an angle to one another: by way of example it is possible to use two layers at an angle of 90° to one another. Alternatively, any desired other angle is also possible. It is also possible to use more than two layers.

The use of metal fibers, preferably in the form of steel cords, steel wires, or steel fibers together with fibers made of another material, for example carbon fibers or glass fibers, permits production of moldings with improved failure behavior.

A semifinished product can by way of example be produced by saturating the fiber structure with a polymer material, in particular with a thermoplastic polymer. Another possibility is to use polymer precursor compounds for this purpose, for example monomers, saturate the fibers with the monomers, and then harden the saturated fiber structure at least to some extent by completing a polymerization reaction.

The saturation of the fiber structure with the polymer precursor compound achieves complete wetting, irrespective of the subsequent shaping processes. The fiber structure thus saturated can then be sheathed with another polymer precursor compound in a following step for the production of the semifinished product. Saturation of the fiber structure with the polymer precursor compound during the sheathing process achieves better adhesion of the polymer precursor compound used to sheath the fiber structure. If no subsequent sheathing with a polymer precursor compound takes place, another result is moreover improved adhesion to the thermoplastic polymer used to sheath the semifinished product in step (b).

When the production of the semifinished product begins by saturating the fiber structure with a polymer precursor compound, and the fiber structure thus saturated is then sheathed with a further polymer precursor compound, it is possible that the polymer precursor compounds used for the saturation process and for the sheathing process are different. In this case it is generally necessary that the polymer precursor compound used for the saturation of the fiber structure is first hardened, and that then, in the next step, the already saturated and hardened fiber structure is inserted into the mold for sheathing by the next polymer precursor compound. In another alternative possibility, a semifinished product with frozen or partially polymerized polymer precursor compound is then sheathed with another polymer precursor compound, for the production of a molding.

When a semifinished product comprising a fiber structure is used, it is moreover advantageous that the polymer used for the production of the semifinished product is the same as the polymer used for the sheathing or coating process. In an alternative possibility, however, the polymer used for the production of the semifinished product can differ from that used for the sheathing or coating process. The use of different polymers is advantageous particularly when the sheathing or coating process is intended to achieve particular properties, for example in respect of surface quality or of strength.

Any desired thermoplastic polymer known to the person skilled in the art can be used for the production of the semifinished product comprising the fiber structure, and also for the production of the sheathed or coated product. Examples of preferred thermoplastic polymers are polymethyl methacrylate, polybutylene terephthalate, polyethylene terephthalate, polycarbonate, polyetheretherketone, polyetherketone, polyether sulfone, polyphenylene sulfide, polyethylene naphthalate, polybutylene naphthalate, polyamide, polypropylene, polyethylene, and mixtures of at least two of these polymers.

When a semifinished product comprising a fiber structure is used for the production of the component, it is possible to use a semifinished product in which the fiber structure has been saturated with a polymer, where the polymer has been polymerized to completion. In an alternative possibility, a semifinished product is used that has been saturated with a polymer precursor compound, and the polymer precursor compound has been solidified but not yet polymerized to completion. In this case, the precursor compound polymerizes by way of example in the mold.

When a semifinished product comprising a fiber structure is used, the semifinished product comprising the fiber structure is in particular a sheet in which the woven-fabric structure has been saturated with the polymers or with a polymer precursor compound. An example of this type of sheet is an organopanel or a thermoplastic laminate.

In one embodiment of the invention, step (b) is used to produce functional elements on the component by the sheathing or coating process. Examples of functional elements of this type are ribs of the type usually molded onto a component made of a polymer material in order to reinforce said component. The functional elements can be not only ribs but also by way of example clips, structures to receive fastening elements, force-introduction elements, or structures to receive screw threads, or any desired other functional elements which can be produced from the polymer material by the injection-molding process.

In order to obtain increased strength it is moreover preferable that the injected polymer forms, between the functional elements, a coherent skin on the fiber structure or on the semifinished product comprising the fiber structure. In particular when a plurality of functional elements are molded alongside one another, the coherent skin between the functional elements achieves additional stabilization of the functional elements. The formation of the coherent skin here results from the presence of a thin flow channel between the functional elements, and injection of the polymer material into the flow channel. The presence of the skin on the fiber structure or on the semifinished product comprising the fiber structure also achieves improved bonding of the polymer material for the functional element to the fiber structure or to the semifinished product comprising the fiber structure.

Another possibility, for improved adhesion of the polymer injected in step (b) on the fiber structure, or on the semifinished product comprising the fiber structure, is to pretreat the fiber structure, or the semifinished product, with a primer before the sheathing process. The primer here can by way of example also serve as adhesion promoter between fiber structure and polymer. An example of a suitable primer material is a soluble polyamide. This is applied in the form of a solution, and the solvent is then removed. A soluble polyamide is particularly suitable when the process of the invention is intended to produce a component made of a fiber-reinforced polyamide.

In particular when a semifinished product comprising a fiber structure is used for the production of the component, it is preferable that the semifinished product comprising the fiber structure is preheated. The preheating softens the polymer material of the semifinished product, and the thermoplastic polymer injected can fuse with the polymer material of the semifinished product and thus form a dimensionally stable bond. The preheating of the semifinished product moreover allows a forming process to be carried out on the semifinished product before or during placing into the injection mold. The forming process carried out on the semifinished product is by way of example required in order to adapt a semifinished product in the form of a sheet so that it is appropriate for the shape of the component to be produced.

The preheating of the semifinished product comprising the fiber structure can by way of example take place in the injection mold for the production of the sheathed or coated product. For this, the semifinished product comprising the fiber structure is inserted into the injection mold, and the injection mold is heated in such a way that the semifinished product comprising the fiber structure is likewise heated. The heating here can be achieved in any desired manner known to the person skilled in the art: it is possible by way of example to heat the injection mold electrically or by using a hot fluid.

In an alternative possibility, the semifinished product comprising the fiber structure is heated before insertion into the injection mold. In this case it is possible to use any desired device known to the person skilled in the art which can heat the semifinished product comprising the fiber structure: it is possible by way of example to heat the mold comprising the fiber structure electrically, by radiant heat, or by microwave radiation, or else to achieve heating by placing it onto a heated plate.

The temperature to which the semifinished product comprising the fiber structure is heated here it is preferably selected so as to soften the polymer of the semifinished product. The temperature here is moreover preferably selected in such a way that the polymer does not yet melt completely, thus preventing escape of polymer from the semifinished product, with resultant damage to the semifinished product.

Additives can be added in order to adjust the properties of the polymer, not only of the polymer of any semifinished product used but also of the polymer used for the sheathing or coating process. Examples of additives usually used are hardeners, crosslinking agents, plasticizers, catalysts, tougheners, adhesion promoters, fillers, mold-release aids, blends with other polymers, stabilizers, and mixtures of two or more of these components. The person skilled in the art is aware of additives, and optionally also comonomers, that can be used to adjust the properties of the polymer.

The component produced by the process of the invention is particularly advantageously a structural component, a bulkhead, a floor assembly, a battery holder, a side-impact member, a bumper system, a structural insert, or a column reinforcement system in a motor vehicle. The component can moreover also by way of example be a side wall, a structural wheel surround, a longitudinal member, or any desired other component of vehicle bodywork.

Another possibility, alongside the use as component in a motor vehicle, is that the component of the invention is a housing of a stone mill, is a protective cage, or is a housing for a turning machine or press machine, or is a load-bearing structure. The process of the invention can produce components with structures of greater robustness than has hitherto been possible in the prior art.

Because of the possibility of production of particularly thin structures, the process of the invention is also particularly suitable for providing an in-mold coating to the component. For this, the surface coating of the component is produced directly in the injection mold. In contrast to conventional coating processes, this achieves good adhesion of the coating material on the molding thus achieving a coating that meets particularly high quality requirements.

The injection of the thermoplastic polymer in step (b) is achieved in the invention under conditions that are conventional for injection molding. In particular when the process of the invention is intended to produce components with thin walls, the use of the polymer-saturated fiber structure has a favorable effect on the flow path length of the polymer in the flow channels. By using a smaller-than-expected number of gates it is possible to coat larger-than-expected areas. It is moreover possible, in particular when the intention is to produce components with relatively large wall thicknesses, to inject the polymer with lower pressure than would have been expected on the basis of the processes known in the prior art. Even a relatively low injection pressure can achieve complete, defect-free filling of the mold when, in the invention, a polymer-saturated fiber structure or a semifinished product comprising a fiber structure, has been inserted.

1. A process for producing a component comprising a polymer material by an injection-molding process comprising:
(a) inserting a polymer-saturated fiber structure, or a semifinished product comprising a fiber structure, into an injection mold;
(b) injecting of a molten thermoplastic polymer into the injection mold in order to sheath or coat the fiber structure, or the semifinished product comprising the fiber structure; and
(c) allowing the polymer to solidify, and removing of the component from the injection mold,
wherein flow channels which surround the fiber structure, or the semifinished product comprising the fiber structure, and which are intended for the molten polymer, have dimensions such that a wall thickness of the component corresponds to a wall thickness for a component not containing an inserted fiber structure.

2. The process according to claim 1, comprising inserting a semifinished product comprising a fiber structure in the form of a sheet in which the fiber structure has been saturated with a polymer precursor compound.

3. The process according to claim 1, wherein the process produces functional elements on the component in step (b).

4. The process according to claim 3, wherein the functional elements are ribs, clips, structures to receive fastening elements, force-introduction elements, or structures to receive screw threads.

5. The process according to claim 3, wherein the injected polymer forms, between the functional elements, a coherent skin on the fiber structure, or on the semifinished product comprising the fiber structure.

6. The process according to claim 1, wherein the semifinished product comprising the fiber structure is preheated.

7. The process according to claim 6, wherein the preheating of the semifinished product comprising the fiber structure occurs takes place in the injection mold.

8. The process according to claim 6, wherein the semifinished product comprising the fiber structure is preheated before insertion into the injection mold.

9. The process according to claim 6, wherein the semifinished product comprising the fiber structure is preheated to a temperature at which the polymer of the semifinished product softens.

10. The process according to claim 9, wherein, before or during insertion into the injection mold, the semifinished product is subjected to a forming process.
